(19) United States
(12) Patent Application Publication
(10) Pub. No.: US 2011/0087504 A1
(43) Pub. Date: Apr. 14, 2011

(54) SYSTEM AND METHOD FOR AGGREGATING DATA OF MULTIPLE LEAD PROVIDERS

(76) Inventor: Lawrence Koa, Dublin, CA (US)

(21) Appl. No.: 12/903,175

(22) Filed: Oct. 12, 2010

Related U.S. Application Data
(60) Provisional application No. 61/251,268, filed on Oct. 13, 2009.
(60) Provisional application No. 61/253,016, filed on Oct. 19, 2009.

(51) Int. Cl. G06Q 40/00; G06F 17/30

(52) U.S. Cl. 705/4; 707/705; 707/E17.044

(57) ABSTRACT

A competitive pricing analysis system and method has a central database with a first bridging application or interface that enables lead providers to provide lead data in a variety of formats. A second bridging application or interface enables clients to retrieve leads from the database and to provide a set of leads to a rating engine. The rating engine then generates premiums from the leads for a plurality of companies. Based on the generated premiums and a comparison thereof, a company is able to analyze their competitive position in the current marketplace.

### CROSS REFERENCE TO RELATED APPLICATIONS

This application claims priority to U.S. provisional patent application Ser. No. 61/251,268, filed Oct. 13, 2009 and 61/253,016, filed Oct. 19, 2009, the contents of which is herein incorporated by reference.

### FIELD OF THE INVENTION

This invention relates to systems and methods for competitive pricing analysis.

### BACKGROUND

The use of “pricing analysis tools” is common practice in the insurance industry. These tools are commonly used to determine an insurance company's competitive position in the marketplace. This is done by using analysis tools to produce pricing and competitive analysis reports based on the insurance company's rates as well as competitor company rates using a set of insurance policies or quotes. The set of insurance policies or quotes used in the analysis tools are typically entered either thru the analysis tool's user-interface or imported to it from some form of a database.

The quality of the resulting analysis reports not only depends on the accuracy of the rates programmed in the pricing analysis tools, but also on the quality of the set of policies or risks used to generate the rates. One of the purposes of running pricing analysis tools is to see how competitive a company is in the marketplace. To be able to do that, the set of risks used to create these reports should be a close reflection of the marketplace. The distribution of risk types (good or bad drivers, economy or high value vehicles, high or low risk areas, etc.) should be as similar as possible to the marketplace. For example, if 30% of the entire marketplace is comprised of drivers of high value vehicles, the set of risks used in the pricing analysis tool should reflect that.

To accomplish this, companies rely on the most realistic insurance policy data they have in their possession, which is the company's own book of business (policies written for current customers). However, companies that only use their own book as a data set must be aware that there could be flaws in relying on only this limited market data.

A company will thus need to determine if the distribution of risk types in the company's book of business is close to the distribution in the marketplace. A company's existing pricing structure may favor certain risk types more than others. Because of this, the company's own book of business will likely have a different distribution for certain risk types compared to the marketplace. For example, if a company's current pricing structure doesn't surcharge premiums for bad drivers as highly as its competitors the distribution of bad drivers in this company's book will tend to be higher than the marketplace. Some companies currently capture quotes from potential customers shopping for insurance, including when a policy is quoted but not purchased and written but these have various limitations. They often contain incomplete information, are limited to where the company currently writes or the focus of their marketing effort, and/or are not of sufficient volume to be representative of the general market.

The company will also need to determine if the reports already indicate that the company's premiums are generally competitive since the company's own book is used. Price is considered to be one of the key decision factors a person uses when choosing an insurer. Therefore, it makes sense that if using a company's own book of business to perform analysis, the quote set used will generally consist primarily of risks with premiums relatively more competitive than business not on its books, provided of course that the company's rates and competitors' rates have not changed materially.

Despite these issues, there is still value in using a company's own book of business and running it thru pricing analysis tools to generate pricing and competitive analysis reports. The results generated from these reports will definitely help a company make pricing decisions to protect that company's book of business. If the company writes in a niche market, this may be the most appropriate approach. However, this is a “defensive” pricing approach when compared to rates for the general public. An alternative approach is an aggressive approach, or an analysis focused more toward challenges in the market and intended to gain market share. To achieve an aggressive approach the data set for analysis must change. Companies need to analyze their book of business and rates in comparison to the actual marketplace to obtain a much more appropriate and effective pricing strategy.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide a set of leads that is indicative of the market;

provide a pricing analysis tool that can generate pricing comparisons based on indicative set of leads;

the ability to use real-world leads to generate premiums for pricing analysis;

the ability to receive leads from a plurality of lead providers in a plurality of formats; and

the ability to provide lead data to a plurality of clients in a plurality of formats.

These and other advantages may be realized by reference to the remaining portions of the specification, claims, and abstract.

### Brief Description of One Embodiment of the Present Invention

A competitive pricing analysis system and method may have a central database with a first bridging application or interface that enables lead providers to provide lead data in a variety of formats. A second bridging application or interface may enable clients to retrieve leads from the database and to provide a set of leads to a rating engine. The rating engine may be used to generate premiums from the leads for a plurality of companies. Based on the generated premiums and a comparison thereof, a company is may be able to analysis their competitive position in the marketplace.

In one aspect, there may be provided a method for competitive pricing analysis. Lead may be provided to and stored in a database. A set of leads may be retrieved and used to generate premiums for a plurality of companies. An output may be generated, such as a report that provides a comparison of the premiums for the plurality of companies.

In one aspect, there may be provided a competitive pricing system. A database may be configured to store a plurality of leads. Leads may be added to the database via a first bridging application and leads may be extracted from the database, e.g. to a pricing analysis tool, via a second bridging application.

In one aspect, there may be provided a competitive pricing system. The system may comprise database means, means for receiving a plurality of leads into the database means and means for retrieving a set of the plurality of leads from the database means. The system may further comprise rating engine means and means for providing the set of leads the rating engine means. The rating engine means may use each lead of the set of leads to generate a plurality of premiums for a plurality of companies. There may also be provided means for generating an output, such as a report, that provides a comparison of the premiums for the plurality of companies.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of the system of the present invention;

FIG. 2 is substantially a schematic view of a leads database to shoppers database bridge interface;

FIG. 3 is substantially a schematic view of a shoppers database to client database bridge interface;

FIG. 4 is substantially a schematic view of a ratings engine; and

FIG. 5 is substantially a flowchart of a pricing analysis method.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

In order to improve market share, a company should use a set of risks that reflect the same risk distributions of people actively shopping for insurance. A good source of these types of risks can be collected from companies that collect insurance leads and sell these leads to agents. There are currently companies providing this service by collecting consumer data including a wealth of risk information from actual insurance shoppers. As the public has become more comfortable with the Internet as a comparative shopping tool, the profile of internet shoppers now reflects that of the public at large to an extent never before realized. To meet the growing need to accurately analyze the marketplace, one or more embodiments of the present invention aggregate the data collected by these insurance lead providers and compile them into a single data set or database. By doing so, a set of risks can be created that contain a more accurate distribution of risk types based on the marketplace of people shopping for insurance. This set of risks can then be used in pricing analysis tools to generate reports that help companies make more accurate pricing decisions to gain market share.

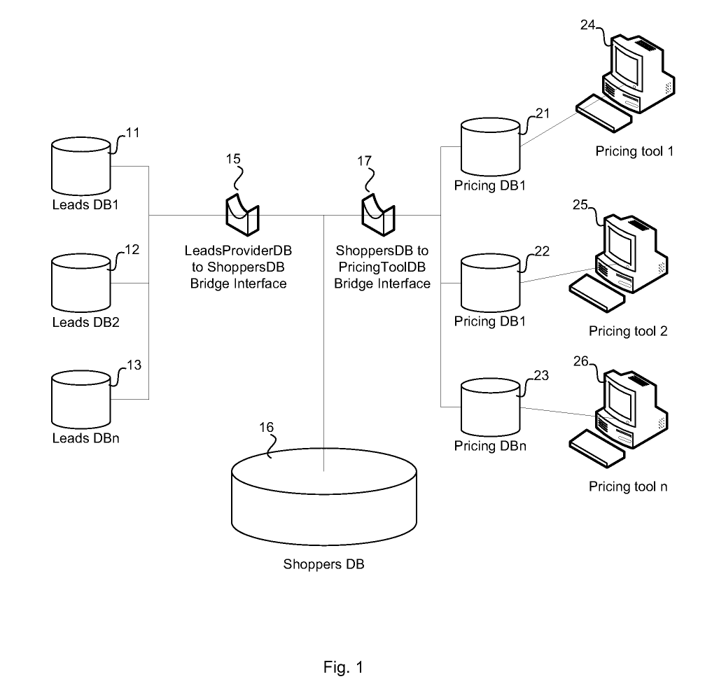

FIG. 1 shows a system 10 in accordance with an embodiment of the invention. The system 10 can be used for collecting and aggregating data on current consumers shopping for insurance in the marketplace. Information is collected from any number of sources and integrated into a useable database format and made available for use in analyzing competitive and comparative strategies for insurance carriers and other companies in the insurance industry.

In the embodiment shown in FIG. 1, individual lead provider databases 11, 12, 13 are created from an aggregate of quote data gathered from shoppers, customers and the like. Lead providers may include companies such as insurance companies, information web portals, lead aggregators, agents, brokers, as well as any other sources for information and data on customers actually shopping or obtaining quotes for insurance. It may include customer survey, quote generating systems or customer requests for information obtained from any number of sources provided the source information includes sufficient information to generate an accurate quote for insurance. The system 10 includes a central database 16, termed a shoppers database, which is used to store data that has been aggregated from the individual lead provider databases 11, 12, 13.

One of the problems is that the data of the lead provider databases 11, 12, 13, is not in a usable format because the quoting companies ask different questions and record the data in different ways. However, the lead provider databases 11, 12, 13 may include a lot of useful information in the data, such as demographic data e.g. age, address, medical conditions, preferred coverage, driving history, etc. Thus, in one embodiment, a bridge interface 15 allows the data of the individual lead provider databases 11, 12, 13, to be manipulated in various ways in order to extract the useful information.

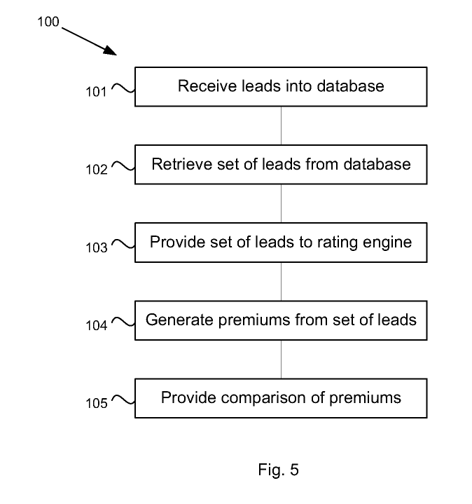

FIG. 5 shows a flowchart 100 of a method for competitive pricing analysis that may be performed using the system of FIG. 1. At step 101, a plurality of leads are received into a database for storage. A set of the leads may be retrieved (step 102) and provided to at least one rating engine (step 103) that uses each lead to generate premiums for a plurality of companies (step 104). At step 105, the rating engine generates a report or similar output that provides a comparison of the premiums for the plurality of companies.

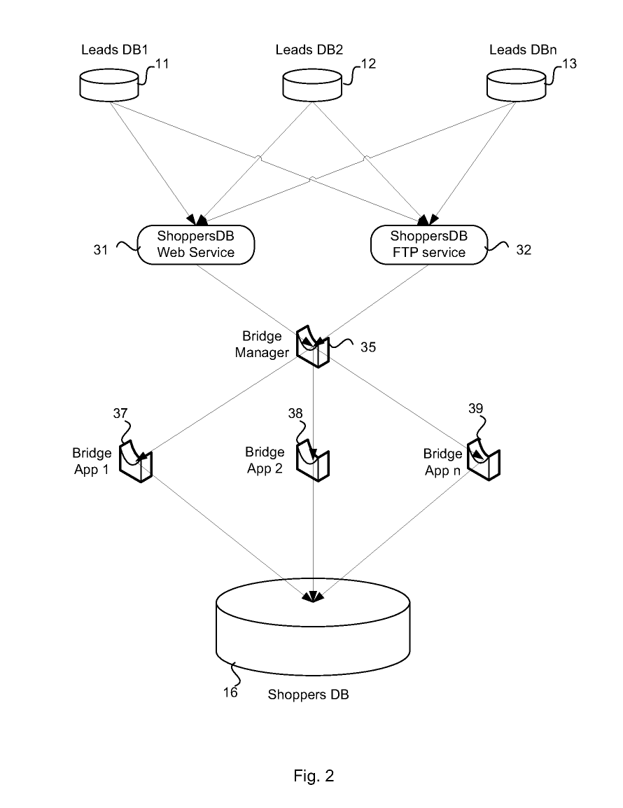

Data collection and integration through the LeadsDB to ShoppersDB Bridge interface 15 is described in more detail with reference to FIG. 2. The LeadsDB To ShoppersDB Bridge Interface 15 includes two main steps:

1) Data Collection; and

2) Data Bridging into the ShoppersDB database.

Data collection is invoked by the lead providers when they submit a lead or a set of leads. For single leads, a webservice 31 is provided to allow the Lead provider to login and send the single lead. The webservice 31 includes properties and methods that allow the lead provider to set the different risk properties of a lead (e.g. age, sex, marital status, model year, make, model, etc) or send the entire lead in an industry standard file format like ACORD XML, a 3rd party file format or the lead provider's proprietary format. In the case of a lead provider's proprietary format, the lead provider will provide file format specifications. A Bridge application 37, 38, 39 is then built to incorporate the lead provider data into the BridgeManager 35.

The Bridge applications 37, 38, 39 allow the Bridge Manager 35 to read 3rd party file formats and import the 3rd party data to the ShoppersDB database as well as, export records from the ShoppersDB database and create 3rd party file formats. Knowing that a lead could be duplicated in different lead providers, the Bridge application will also attempt to remove duplicate leads. This is done by looking for matches to certain lead characteristics, such as home address, garaging address and/or telephone numbers.

Once the webservice 31 accepts the lead, it will send the lead to the BridgeManager 35. The BridgeManager 35 then determines the appropriate Bridge application 37, 38, 39 to use to import the lead into the ShoppersDB 16.

For multiple leads, the lead provider can either invoke the webservice 31 multiple times or upload the leads to the ShoppersDB FTP site 32 (a more efficient way of sending data across the internet). When uploading the leads via the FTP site 32, the leads can be either in an industry standard file format like ACORD XML, a 3rd party file format or the lead provider's proprietary format.

The BridgeManager 35 is also a service that runs in the server that hosts the FTP site 32. This service will periodically check the FTP site 32 (once every 24 hours for example) for new leads in the FTP site 32. If new leads are found, it will then determine the appropriate Bridge application 37, 38, 39 to use and call that application to import the leads into the ShoppersDB 16.

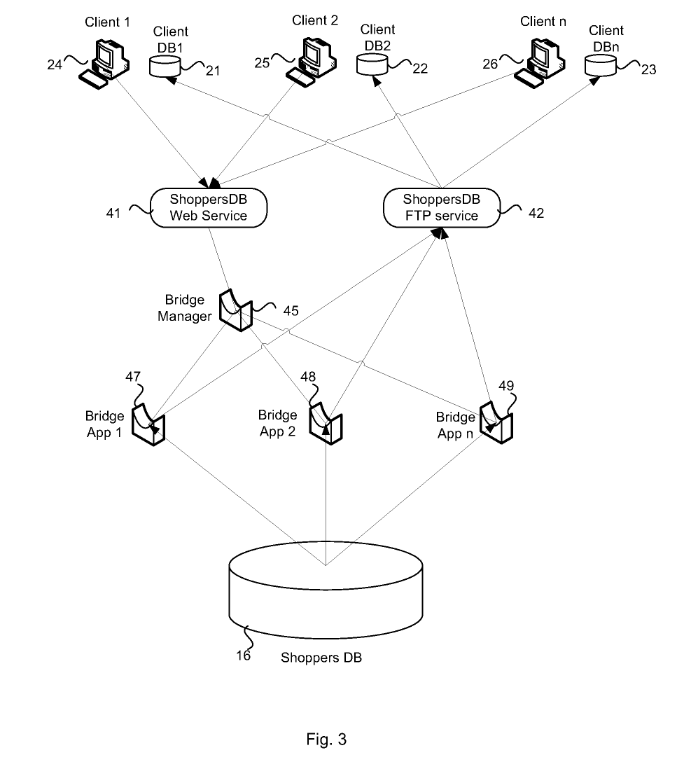

Lead distribution to clients is handled through the ShoppersDB To ClientDB interface 17 which is shown in more detail in FIG. 3. The ShoppersDB to ClientDB interface 17 consists of two steps:

1) Lead query and filter; and

2) Download or request leads.

A website 41 is created to allow clients to login, query and filter, download or request leads. The query for leads can be filtered based on certain lead characteristics like lead creation date, current policy expiration dates, driver age, etc. Once the query is made, the user can download the leads from an FTP site 42 or request the leads to be sent to them in a storage media like a DVD, for example if the lead request is very large.

The website 41 allows the user to choose what file format they want the leads to be in. This allows the BridgeManager 45 to decide which Bridge application 47, 48, 49 to use when converting from a ShoppersDB lead to a ClientDB lead.

Through the ShoppersDB to Client DB Bridge Interface 17, aggregated data of the shoppers database 16 can be used by the insurance companies and others for various tasks, such as analyzing the marketplace to design new products. The data of the shoppers database 16 may be made available to any system of analysis, such as the client pricing databases 21, 22, 23 and their respective pricing tools 24, 25, 26 for rates, quotes or other competitive or comparative data. The shoppers database 16 may be accessed through a ShopperDB to PricingToolDB bridge interface 17 that allows the respective pricing databases 21, 22, 23 to extract the shoppers database data in an acceptable format.

The lead data may be extracted via a suitable bridge interface 17 into a pricing analysis tool 24, 25, 26. The pricing tool uses the data from the ShoppersDB to create competitive analysis reports. Competitive analysis reports are reports that help an insurance carrier determine its competitive standing in the marketplace. The report format for these reports are customizable by the end user and would usually contain information like average premiums, average wins, average rank, average dollar difference and premium percent difference for each insurance carrier in certain market segments in the ShoppersDB.

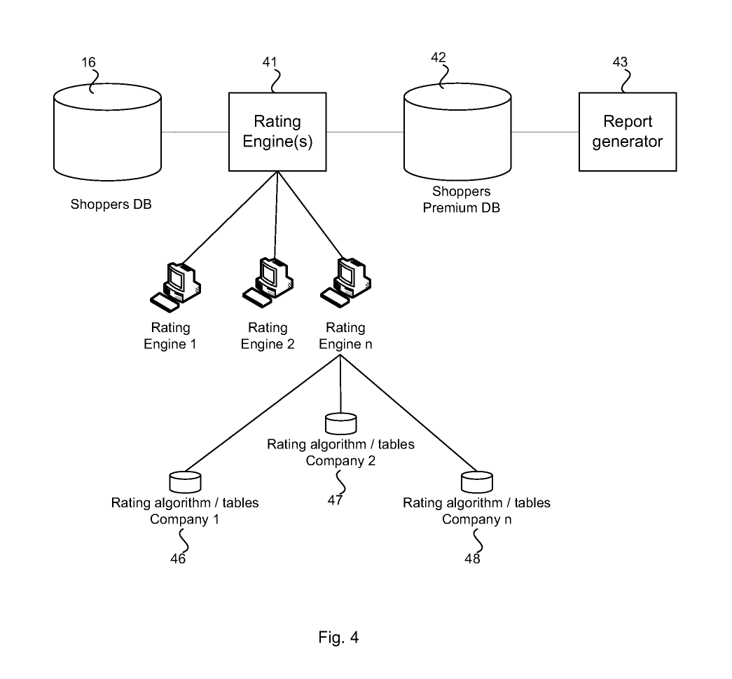

An embodiment of a pricing tool 40 is shown in FIG. 4. The pricing tool 40 includes one or more rating engines 41. The rating engine 41 receives lead data from the ShoppersDB 16. For each lead received, the rating engine calculates a premium for each insurance company available in the rating engine. A typical rating engine, e.g. rating engine n, may include rating algorithms and/or rating tables 46, 47, 48 for various companies that enable the rating engine to calculate a premium based on risk profile information and other demographic data that may be provided in each lead.

The premium results are stored in an interim ShoppersPremium database 42. This database may include records with a leadID column (to identify the lead), a companyID column (to identify the company rated) and a premium column (to store the premium).

Once all the leads are rated and stored in this interim database, a report generator module 43 collates the lead data and premium data to generate various reports, including comparative reports.

Table 1 below shows an example of premiums generated by the rating engine for Company 1 divided into age group categories.

TABLE 1
Company 1 premiums

| | | | Company 1 | | |
|---|---|---|---|---|---|
| | | | Avg | Avg | Avg |
| Household Age Group | #Quotes | Weight | Premium | Wins | Rank |
| Youthful | 19,358 | 14.68% | $2,056.79 | 5.2 | 2.8 |
| Adult with Youthful | 5,202 | 3.94% | $3,163.67 | 4.3 | 3.7 |
| Young Adult | 17,358 | 13.16% | $1,507.67 | 5.1 | 2.9 |
| Adult | 50,575 | 38.34% | $1,268.55 | 5.5 | 2.5 |
| Mature Adult | 24,615 | 18.66% | $1,137.28 | 5.7 | 2.3 |
| Early Senior | 4,622 | 3.50% | $1,039.89 | 5.8 | 2.2 |
| Senior | 8,030 | 6.09% | $1,045.08 | 5.9 | 2.1 |
| Adult with Senior | 2,136 | 1.62% | $1,419.24 | 5.7 | 2.3 |
| Totals | 131,896 | 100.00% | $1,446.78 | 5.4 | 2.6 |

Table 2 below shows premiums generated by the rating engine for Company 2.

TABLE 2
Company 2 premiums

| | | | Company 2 | | | | |
|---|---|---|---|---|---|---|---|
| Household Age | | | Avg | Avg | Avg | Avg Dollar | Percent |
| Group | #Quotes | Weight | Premium | Wins | Rank | Diff | Diff |
| Youthful | 19,358 | 14.68% | $1,831.63 | 5.5 | 2.5 | ($225.16) | −10.90% |
| Adult with Youthful | 5,202 | 3.94% | $2,598.74 | 5.5 | 2.5 | ($564.92) | −17.90% |
| Young Adult | 17,358 | 13.16% | $1,482.78 | 5 | 3 | ($24.89) | −1.70% |
| Adult | 50,575 | 38.34% | $1,265.36 | 5.3 | 2.7 | ($3.19) | −0.30% |
| Mature Adult | 24,615 | 18.66% | $1,124.62 | 5.6 | 2.4 | ($12.67) | −1.10% |
| Early Senior | 4,622 | 3.50% | $1,051.94 | 5.6 | 2.4 | $12.05 | 1.20% |
| Senior | 8,030 | 6.09% | $1,116.43 | 5.2 | 2.8 | $71.35 | 6.80% |
| Adult with Senior | 2,136 | 1.62% | $1,384.40 | 6 | 2 | ($34.84) | −2.50% |
| Totals | 131,896 | 100.00% | $1,388.79 | 5.3 | 2.7 | ($57.99) | −4.00% |

Also included in Table 2, are columns showing the average dollar difference and percentage difference for each risk category relative to the average premium of Table 1. Such columns might form the basis of reports generated by the report generator module 43. Reports may include comparisons between two or more companies, an indication of where in the overall market the company under analysis lies, as well as very specific indications such as analysis per category, per insurance type, per geographic area etc. While a simple table is depicted, the reports may include more complex graphics, charts and data presentation methods. These reports may be made more specialized and detailed by filtering the data received into the pricing tool and/or by filtering the data stored in the Premium database 42.

It can be seen from the foregoing that the use of lead data in the pricing analysis tool as opposed to, say, a company's own book of business, can provide analysis that is more indicative of the real marketplace. For example, Tables 1 and 2 each show the number of quotes per category as well as an indication of what percentage of the marketplace these categories represent. While the categories shown in Tables 1 and 2 are age brackets, other categories are viable. For example, categories may be provided for geographic area, liability limits, comp. deductibles, credit rating, whether the insured is a homeowner, marital status, gender, student rating (i.e. whether the insured was a good student), etc. That is, the data may be categorized according to virtually any demographic data that is provided in the lead information.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for competitive pricing analysis comprising:
(A) receiving a plurality of leads into a database;
(B) retrieving a set of the plurality of leads from the database;
(C) providing the set of leads to at least one rating engine that uses each lead of the set of leads to generate a plurality of premiums for a plurality of companies;
(D) generating an output that provides a comparison of the premiums for the plurality of companies.

2. The method of claim 1 wherein receiving a plurality of leads into the database comprises receiving a batch file of leads from a lead provider.

3. The method of claim 2 comprising providing a bridge interface to the database that enables a lead provider converts the batch file of leads into a format usable by the database.

4. The method of claim 1 comprising providing a bridge interface from the database that enables the set of leads to be retrieved in a third party format.

5. The method of claim 1 wherein comprising storing the plurality of premiums for the plurality of companies in a premiums database.

6. The method of claim 5 wherein generating the output comprises processing the data of the premiums database.

7. The method of claim 5 wherein generating the output comprises generating one or more reports that provides a comparison of premiums for the set of leads for a plurality of companies.

8. The method of claim 7 wherein the one or more reports indicate a difference between the premiums for the set of leads for the plurality of companies.

9. A competitive pricing system comprising:
(A) a database configured to store a plurality of leads;
(B) at least one first bridge application configured to provide an interface for providing leads to the database; and
(C) at least one second bridge application configured to provide an interface for retrieving at least one set of leads from the database.

10. The competitive pricing system of claim 9 wherein the at least one bridge application is configured to receive a file comprising a plurality of leads in a first format and convert the leads into a format to be stored in the database.

11. The competitive pricing system of claim 9 wherein the at least one second bridge application is configured to convert a set of leads retrieved from the database into a third party format.

12. The competitive pricing system of claim 9 comprising at least one rating engine configured to receive a set of leads from the database and to generate a plurality of premiums for a plurality of companies from each lead of the set of leads.

13. The competitive pricing system of claim 12 comprising at least one second database for storing the generated premiums.

14. The competitive pricing system of claim 12 wherein the at least one rating engine comprises at least one rating algorithm or rating table and wherein the at least one rating engine is configured to apply data from at least one lead of the set of leads to the at least one rating algorithm or rating table to generate the premium.

15. The competitive pricing system of claim 9 comprising at least one report generator that is configured to generate one or more reports that provide a comparison of premiums generated for a plurality of companies from the set of leads.

16. A competitive pricing system comprising:
(A) database means for storing a plurality of leads;
(B) means for receiving a plurality of leads into the database means;
(C) means for retrieving a set of the plurality of leads from the database means;
(D) means for providing the set of leads to at least one rating engine means;
(E) rating engine means for generating a plurality of premiums for a plurality of companies from the set of leads; and
(F) means for generating an output that provides a comparison of the premiums for the plurality of companies.
